(19) United States
(12) Patent Application Publication
(10) Pub. No.: US 2015/0268079 A1
(43) Pub. Date: Sep. 24, 2015

(54) TRACER PARTICLE FOR MONITORING PROCESSES IN AT LEAST ONE FLUID PHASE AND METHODS AND USES THEREOF

(71) Applicant: SINVENT AS, Trondheim (NO)

(72) Inventors: Are Lund, Trondheim (NO); Lars Kilaas, Trondheim (NO); Paal Skjetne, Trondheim (NO)

(21) Appl. No.: 14/435,282

(22) PCT Filed: Oct. 16, 2013
(86) PCT No.: PCT/NO2013/050174

§ 371 Date: Apr. 13, 2015

(30) Foreign Application Priority Data
Oct. 16, 2012 (NO) 20121197

(51) Int. Cl. G01F 1/704; E21B 47/10

(52) U.S. Cl. CPC G01F 1/704; E21B 47/1015

(57) ABSTRACT

The invention concerns a tracer particle for monitoring processes in a system, where the system comprising a fluid with at least one fluid phase. The tracer particle comprises an integrated circuit (IC) providing a unique identification of the tracer particle, wherein the integrated circuit is enclosed/embedded in a coating/shell providing specific properties to said tracer particle in relation to at least one of i)said fluid; ii)ambient conditions in said system; and iii) detectability of the tracer particle. Methods for monitoring processes in a system by using the tracer particle is also disclosed, along with uses of the tracer particles.

### FIELD OF THE INVENTION

The present invention relates to the field of tracing fluids. Specifically it presents a method and device(s) and uses for the application of IC (integrated circuit) technology as tracers for both characterizing and monitoring of process fluids and process conditions.

### BACKGROUND OF THE INVENTION

A major challenge in process industries is the characterization of the processing conditions. Direct and indirect measurement techniques of processing conditions are widely used. Direct methods include thermocouples, pressure transducers, optical sensors (spectroscopic), flow meters, and sensors for chemical composition to name a few. In common these methods all perform localized measurements, either at a point or in a limited sampling plane or volume. Indirect methods include direct methods coupled to mathematical models which can be used to infer the state of the system. Tracers form the basis for several indirect measurement techniques. A tracer is a chemical or physical label that can be sensed using various detection methods. Some examples are: nuclear isotopes, fluorescent compounds, chemicals with known spectroscopic signatures, chemicals that can be quantified using chemical analysis and particles that give rise to light scattering or reflection.

Nuclear isotopes are widely used in medical, industrial and research applications. The nuclear isotopes can be incorporated into chemicals which are then released into the process system. The spatial and temporal distribution of the labeled chemicals in the system can then be monitored using e.g. tomographic methods (e.g. PET) or chemical analysis of samples. The latter technique allows chemical pathways to be mapped. In other cases the tracers are not nuclear isotopes but chemical compounds that absorb or scatter x-rays or y-rays, such chemical compounds are known as contrast agents, and may or may not be used also in projection radiography (normal x-ray examinations). Another commonly used group of tracers are fluorescent compounds, i.e. compounds that emit radiation in response to absorption of electromagnetic energy. Other chemical tracers commonly used in e.g. tomographic techniques include compounds that have a well defined spectroscopic signature for absorption of electromagnetic energy (infra red, visible light, ultraviolet light, x-rays and y-radiation). Furthermore, physical labels include particles and bubbles such as titanium oxide and hydrogen bubbles which in clear fluids give a strong optical contrast, e.g. light scattering or reflection.

Major challenges with existing tracer systems available to industry and research organizations today are:
(i) radioactive tracers pose undesirable HSE risks,
(ii) complicated and cost intensive detection systems,
(iii) non opaque systems suffer from limited visibility and systems under high temperature and pressure suffer from limited field of view,
(iv) need for manual/semiautomatic sampling and analysis,
(v) incompatibility of tracer with process fluids,
(vi) only a single or very limited number of tracers exist and can be used simultaneously, or
(vii) are difficult to separate from the process fluids after use.

Temporal and spatial resolutions of existing methods are limited by tracer dispersion and acquisition sensitivity (e.g. with respect to concentration or time). A notable exception to challenge (vi) is the use of e.g. DNA segments as tracers, in which case the number of unique tracers is proportional to the number of nucleotide segments to the power of 4.

It is known to use radio frequency identification systems, RFID, and RFID tags to control positioning of downhole tools during oil and gas exploration, drilling, completion and operation of wells. RFID-tags may be embedded into the formation of oil and gas wells, or into the completion or tools attached to the completion (e.g. pup-joints) of such wells. It is known that RFID-tags coupled to sensor are used to measure temperature and pressure in the formation next to a wellbore. The prior art on RFID technology does not describe the specific application of the technology as tracers for characterizing fluids or process conditions. Specifically the art limits the use of the technology to non-liquid systems. Most applications consider RFID-tags affixed to solid objects and signal communication is through a gaseous atmosphere. Specifically tracing of liquids (e.g. mineral water) inside containers is often referred to as an example of an unsuited application of the technology. The reason for this statement is the assumption that the RFID-reader (receiving antenna) will be located on the outside of the container. The metallic containers act as Faraday electromagnetic shields preventing the radiation from penetrating the container. Furthermore, the main application of RFID-technology today is in the field of logistics, inventory, source of origin/authenticity, information about/for analysis of supply chains and instructions for use along assembly lines. Finally RFID is set to replace the traditional bar code within the retail sector encapsulating all product information when coupled to a product database at points of sale or transfer.

In e.g. a bubble-, (or slurry-bubble-column or fluidized bed), radioactive tracers are used to estimate fluid mixing and strength of fluid circulation. The sensitivity of the tomographic detection systems require long acquisition times. Dispersive mixing reduces the temporal resolution, whereas a limited number of detectors reduce the spatial resolution. For most applications isotopes with relative short half times are used in order to reduce HSE exposures and risks. In some cases, due to HSE regulations such product batches may not be marketed, thus representing a loss of production. Thus, such tracer systems can only give coarse grained and time averaged information about flow conditions in the process, at given intervals often in conjunction with periodic maintenance. X-ray transmission tomography, ultrasound and NMR imaging are also used to characterize multiphase pipe flows and multiphase processing conditions. Such techniques can be used to continuously monitor the process. Again spatial or temporal resolution is a problem due to low contrast and long acquisition times.

For transparent fluids high temporal and spatial resolution may be obtained using laser based systems seeded with minute particles such as PIV and PLIF methods (in the latter method the laser light induces fluorescence in the seed particles) or dissolved fluorescent chemicals (LIF). Such methods require transparent fluids and are limited and difficult to adapt to real industrial processing conditions.

Thus, tracers are a useful and common means to characterize dispersion and monitor flowing processes. A number of both physical and chemical tracers are used for this purpose: radioactive, fluorescing, chemical (spectroscopic or compositional), acoustic or light reflectors (bubbles and particles).

### SUMMARY

The present invention relates to integrated circuits as tracers for monitoring processes in a system comprising a fluid with at least one fluid phase.

In an aspect the invention provides a tracer particle for monitoring processes in a system, said system comprising a fluid with at least one fluid phase, wherein the tracer particle comprising:

an integrated circuit (IC) providing a unique identification of the tracer particle, wherein the integrated circuit is enclosed/embedded in a coating/shell providing specific properties to said tracer particle in relation to at least one of

i said fluid;

ii ambient conditions in said system; and

iii detectability of the tracer particle.

The tracer particle is further provided with either at least one terminal enabling electric connection of the tracer particle to a tracer particle reader device or an embedded electromagnetic coupling module enabling near field communication with a tracer particle reader device.

The integrated circuit may be connected to the at least one terminal through wiring embedded in the coating/shell.

In an embodiment the coating/shell is provided with surface modifications or embedded modifications. The shell may be selected to provide the tracer particle with at least one specific property selected from a group comprising:

a protection against aggressive properties of said fluid,

b miscibility with at least one of said fluid phases,

c specific size,

d specific density,

e wear resistance,

f electrical properties,

g magnetic properties,

h optical properties, and

j ability to self-assemble on accommodated surfaces.

The tracer particle may further comprise optional attachments selected from a group comprising: an antenna; a sensor, and an electrical socket. The integrated circuit may be provided with a power supply and/or power management unit. Further, the integrated circuit may be provided with embedded terminals or a transmission unit for interrogation. An RFID antenna may be connected to the embedded terminals. A sensor may be connected to the embedded terminals.

In a further aspect, the invention provides a reader device for a tracer particle according to above, the reader device comprising: a surface area for assembling and readout of a number of tracer particles, the surface area comprising a number of readout locations. Each readout location is provided with either a contact device enabling electric connection to at least one terminal of a tracer particle or an electromagnetic coupling device enabling near field communication with an embedded electromagnetic coupling module of a tracer particle.

The readout locations may further be provided with a chemical surface modification compatible to a chemical surface modification of the tracer particles. The readout locations may be provided with a surface modification corresponding to a shape of the tracer particles. The reader may further comprise a guiding device aiding tracer particle migration towards the surface area. The guiding device may further comprise a manipulating device, e.g. in the form of a swirl element, operative for manipulating a local flow field. The guiding device may further comprise a device setting up local electric or magnetic fields aiding tracer particle migration towards and tracer particle assembly onto the surface of the readout device.

The tracer particles and at least one reader device may be used for determining origins of the tracer particles in a system comprising a fluid with at least one fluid phase.

In a further aspect the invention provides a method for monitoring processes in a system, said system comprising a fluid with at least one fluid phase, said method comprising: adding at at least a first location at least one tracer particle as defined above to at least one of said system and fluid, and detecting and identifying said tracer particle at at least one second location. The method may further comprise separating the at least one tracer particle from the fluid before detection and identification at the second location.

The method may further comprise deriving specific information from said tracer particle at said second location; and unambiguously distinguishing said tracer particle from other tracer particles or groups of tracer particles. Further, the method may comprise monitoring dispersion of more than one fluid phase by adding tracer particles with phase-specific miscibility to at least one of said system and fluid and identifying the dispersion of the tracer particles in at least one spatial direction in said system or fluid. A transition zone between at least two different fluid qualities or fluid origins passing consecutively through a part of said system may be identified by adding at least one detectable tracer particle into said transition zone between the at least two different fluids. At least one of said different fluid qualities may further be passed to a selected part of said system, said selection being performed on the basis of said transition zone identification. At least one tracer particle may be added into said fluid when said fluid changes at least one of its properties due to ambient changes.

In an embodiment the method provides monitoring wear of a surface of said system by arranging at least one tracer particle below said surface of the system and detecting said at least one tracer particle at a different location in said system indicating wear on said surface. Tracer particles with different detectable identity may be arranged in layers on said surface enabling monitoring of said wear in a quantifying manner.

When said fluid is a production material intended for use in a production process, the method further may further comprise adding a plurality of tracer particles to said production material at said first location, and monitoring said production course and/or production quality of material of process at said second location during and after said production. The production process may be a storage process where said production material constitutes a material to be stored in a container. The production process may be a molding process and said production material may be a molding material.

In further aspect, the invention provides use of at least one tracer particle as defined above for tracing at least one of single- and multiphase fluids for characterization of process fluids and processing conditions. Short and long time autocorrelation or cross correlation functions in single- or multiphase flows in pipes may be obtained. The flow may be an oil/gas/condensate transport or water supply.

In an even further aspect, the invention provides use of at least one tracer particle as defined above for reservoir monitoring including controlled release in oil and gas reservoirs. The invention also provides use of at least one tracer particle as defined above for monitoring at least one of aquifers, water wells, water pipelines and sewage networks. Short and long time autocorrelation or cross correlation functions in single- or multiphase flows in reactors including fluidized beds, bubble columns, slurry bubble columns and packed beds may be obtained. Further, short and long time autocorrelation functions in single- or multiphase flow processing equipment, said processing equipment including at least one of cyclones, gravity separators, inline separators, scrubbers, flotation cells, screws, conveyors, silos, pumps, valves, coalescers, heat exchangers, absorbers, adsorbers, desorbers, injection moulding equipment, blow moulding equipment, hoppers and silos may also be obtained.

The combination of the above attributes, and the application of IC-technology as tracers to monitor process fluids and process conditions is what makes this invention stand out from previous work.

### BRIEF DESCRIPTION OF THE DRAWINGS

Example embodiments of the present invention will be described with reference to the attached drawings where:

FIG. 1-a schematically shows an IC (integrated circuit) tracer particle with an IC-tag wrapped inside a shell, according to an embodiment of the invention.

FIG. 1-b schematically shows an IC-tracer particle where an IC-tag wrapped in a shell whose surface has been modified to aid recovery and/or interrogation of the particle, according to an embodiment of the invention.

FIG. 1-c schematically shows an IC-tracer particle where an IC-tag wrapped in a shell which also contains other embedded inclusions which are used to aid recovery and/or interrogation of the particle, according to an embodiment of the invention.

FIG. 1-d schematically shows an IC tracer particle with an IC-tag wrapped inside a shell of a tailored shape, according to an embodiment of the invention.

FIG. 1-e illustrates the IC tracer particle from FIG. 1-a provided with electrical contacts.

FIG. 1-f illustrates the IC tracer particle from FIG. 1-b with surface modifycations and provided with electrical contacts.

FIG. 1-g illustrates the IC tracer particle from FIG. 1-c with embedded modifications and provided with electrical contacts.

FIG. 1-h illustrates the IC tracer particle from FIG. 1-d with tailored shape and provided with electrical contacts.

FIG. 2-a schematically shows an IC tag according to an embodiment of the invention. The tag in FIG. 2-a has an IC, and a “front end” which supplies the IC with power and coupling points to an antenna which is used for interrogation, according to an embodiment of the invention.

FIG. 2-b schematically shows a RFID-tag with antenna embedded in a protective shell, as an embodiment of an IC-tracer particle for RF interrogation.

FIG. 2-c schematically shows an IC-tracer particle wrapped in a shell with surface modifications and electromagnetic coupling module that can be used to interrogate it, according to an embodiment of the invention.

FIG. 3-a schematically illustrates use of IC tracer particles for monitoring of fluid dispersion in a pipe according to an embodiment of the invention.

FIG. 3-b schematically illustrates use of IC tracer particles for monitoring fluid dispersion within a tank according to an embodiment of the invention.

FIG. 3-c schematically illustrates use of IC tracer particles for monitoring fluid dispersion in a fluid bed reactor according to an embodiment of the invention.

FIG. 3-d schematically illustrates use of IC tracer particles for characterization of residence time distribution in a continuous process using batch wise addition of IC-tracers, e.g. single or multiphase chemical reactors, or for characterization of material flow in hoppers/silos, according to an embodiment of the invention.

FIG. 3-e schematically illustrates use of IC tracer particles for erosion monitoring (either mechanical or chemical wear) according to an embodiment of the invention.

FIG. 3-f schematically illustrates use of IC tracer particles for flow rate monitoring and phase distribution according to an embodiment of the invention.

FIG. 3-g schematically illustrates use of IC tracer particles for characterization of material flow in injection moulded parts according to an embodiment of the invention.

FIG. 4 illustrates a part of a readout device for an IC tracer particle according to an embodiment of the invention.

### DETAILED DESCRIPTION

The invention provides a new type of tracers for fluids and specifically, but not limited to, process fluids. These tracers are particles, and will hereinafter be referred to as IC-tracer particles” or just “tracers”. The tracer particles may be used for monitoring processes in a system comprising a fluid with at least one fluid phase.

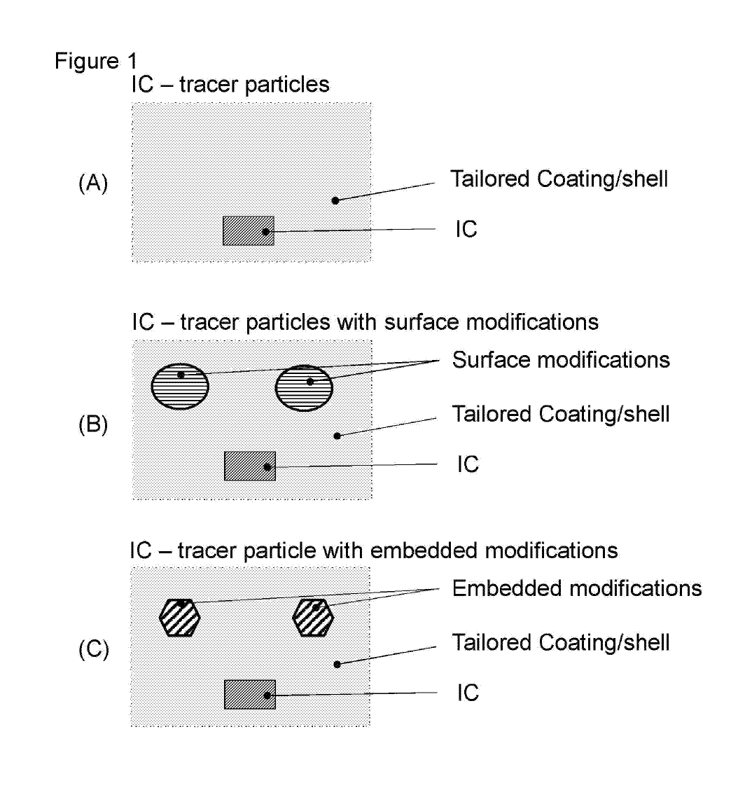

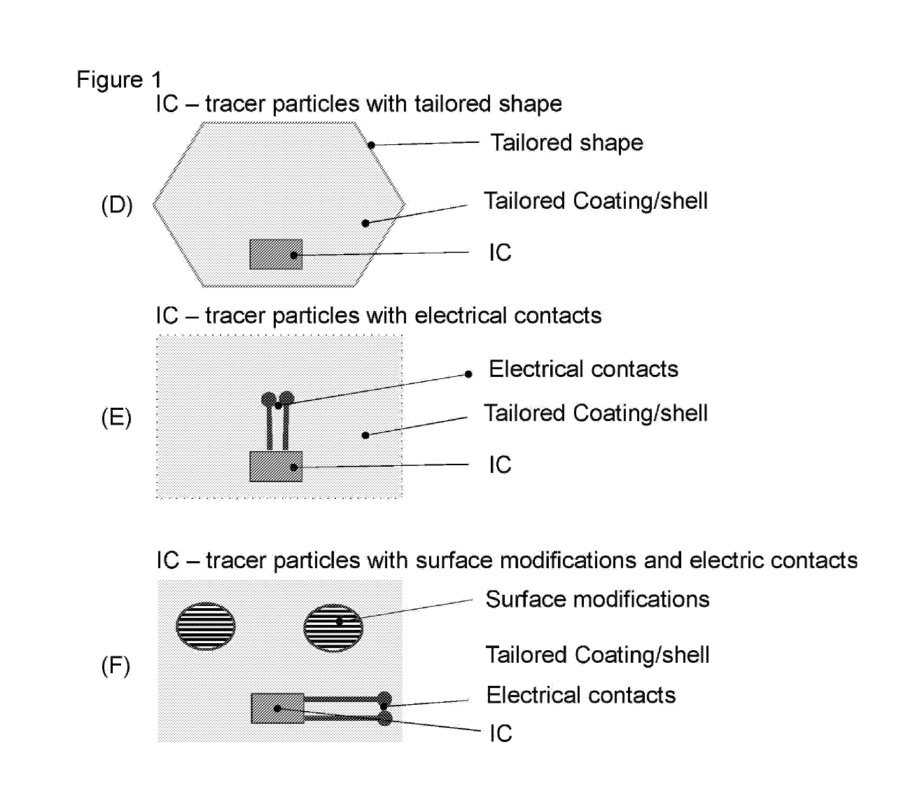

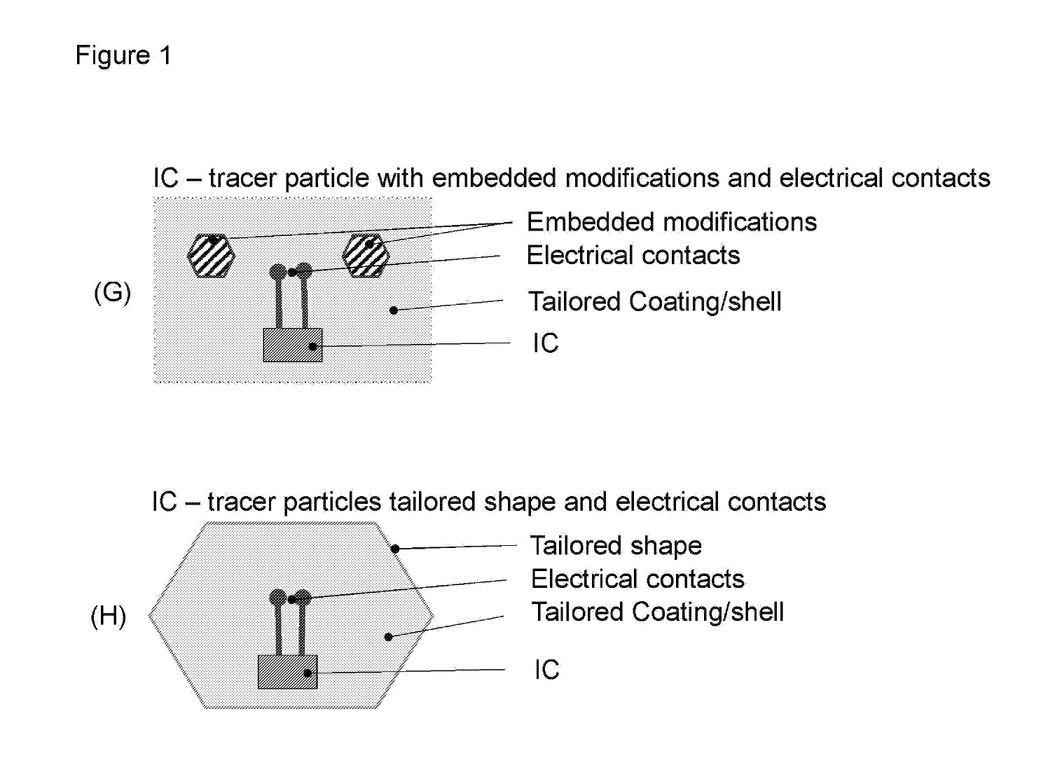

A tracer particle with an integrated circuit (IC) is shown in FIG. 1. The integrated circuit (IC) provides a unique identification of the tracer particle. The integrated circuit may be e.g. a unique-type IC storing a binary ID or a non-unique type IC sharing a binary ID with a number of other IC's.

The IC (integrated circuit) is wrapped/embedded/enclosed inside a shell or coating. The shell or coating may or may not be a protective shell or coating. The coating or shell may be provided with surface modifications or embedded modifications. The coating/shell provides specific properties to said tracer particle in relation to at least one of said fluid; ambient conditions in said system; and detectability of the tracer particle. For a process fluid, the coating may be tailored to at least one of the process fluids, the processing conditions, the recovery, detection and interrogation (readout) of the tracer particles. The shell may provide the tracer particles with at least one specific property selected from a group comprising:
protection against aggressive properties of said fluid,
miscibility with (i.e. disperses preferably into) at least one of said fluid phases,
specific size,
specific shape,
specific density,
wear resistance,
electrical properties,
magnetic properties,
optical properties, and
ability to self-assemble on accommodated surfaces.

The tracer particle may comprise optional attachments. These attachments may comprise at least one of an antenna, a sensor and an electrical socket.

FIG. 1-b shows an embodiment where an IC-tracer particle is wrapped in a shell. The surface of the shell is modified to aid recovery and/or interrogation of the particle. Such modifications to the shell may include but are not limited to:
shape
wetting/solubility properties,
abrasiveness,
optical properties
ability to self assemble onto designed surfaces,
electric and magnetic properties.

A further embodiment is shown in FIG. 1-c where an IC-tracer particle is wrapped in a shell. The shell contains other embedded modifications which are used to aid recovery and/or interrogation of the particle. Such modifications may include but are not limited to:
density,
optical properties
electric and magnetic properties,

For tracing of two or more immiscible fluid phases, such as in an oil/water/gas fluid stream, an IC tracer particle can be tailored so that it is protected from the physiochemical effects of all phases, and surface treated so that it preferentially disperses itself into only a subset of the phases. The IC-tracer particles can be tailored with respect to, but not limited to:
size,
shape
wetting/solubility properties,
abrasiveness,
density,
optical properties
ability to self assemble onto designed surfaces,
electric and magnetic properties,
   such that the intended functionality, integrity, recovery and interrogativity of the IC-tracer particles are ensured.

The IC tracer particle is tailored to each specific application. This includes both size and choice of materials. The materials of the coating/shell are selected in order to be compatible with the chemical compounds in the system of interest.

FIG. 1e illustrates the IC tracer particle from FIG. 1a provided with electrical contacts. FIG. 1f illustrates the IC tracer particle from FIG. 1b with surface modifications and provided with electrical contacts. FIG. 1g illustrates the IC tracer particle from FIG. 1c with embedded modifications and provided with electrical contacts. FIG. 1h illustrates the IC tracer particle from FIG. 1d with tailored shape and provided with electrical contacts. The integrated circuit is connected to the electrical contacts through wiring embedded in the coating/shell. The electrical contacts provide terminals enabling electric connection of the tracer particle to a tracer particle reader device.

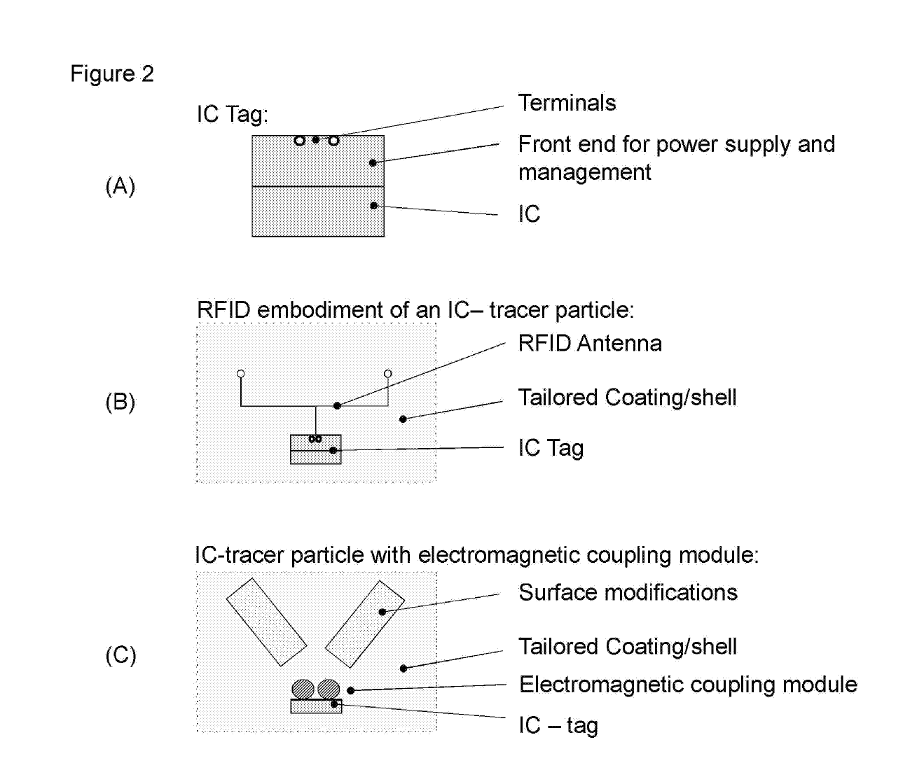

The IC (integrated circuit) in the tracer particle may function as a tag for the tracer particle, enabling unique identification of each tracer particle. The tag is in FIG. 2a an IC-tag. The embedded IC in the tracer particle is provided with a power supply and/or power management unit. An optional “front end” may be provided for the power supply and/or power management to the IC. The power supply and management unit is provided with terminals which are used for interrogating the IC.

FIG. 2b shows an RFID embodiment of an IC tracer particle. FIG. 2b shows the IC tag from FIG. 2a provided with an antenna connected to the embedded terminals or optionally connected to the terminals of the “front end”. The IC tag with an antenna is effectively a RFID chip. This RFID chip is then embedded in a protective shell. The protective shell may be tailored as explained above. The embodiment shown in FIG. 2b is thus an RFID-tracer particle for RF interrogation. It should be noted that the interrogation is not limited to the standard RFID frequency bands, e.g ISO/IEC18000 encompassing: 135 kHz, 13.56 MHz, 2.45 GHz, 860-960 MHz, 433 MHz, or in terms of frequency bands: low frequency range 125-150 kHz, high frequency 13.56 MHz or ultra high frequency 868-928 MHz. Further, a sensor may be connected to the embedded terminals.

Furthermore, RFID-tags can be made of two types, passive and active. The passive RFID-tags only transmit their ID when stimulated by an external electromagnetic field, whereas active RFID-tags can transmit their ID using an internal power source. An active RFID-tag can also process information received either from the reader or from a connected sensor. The ability to process information from an external source can be used to reset/change the ID of the tracer. This is potentially a powerful attribute for studies in batch processes or for estimating autocorrelation functions in processing environments. The ability to process information from a connected sensor is potentially equally powerful enabling the tracers to transmit/convey information about current or integral (accumulated history) state of the tracer.

FIG. 2c shows an IC tracer particle with an electromagnetic coupling module. The IC tracer particle comprises the IC tag from FIG. 2a, and the IC tag is provided with an electromagnetic coupling module connected to the “front end”. This electromagnetic coupling module can be used to interrogate the IC tag. The IC tag with the electromagnetic coupling module is fully wrapped/enclosed/embedded in a tailored shell. The shell is provided with surface modifications adapted to the specific use. The electromagnetic coupling module may use either near field inductive or capacitive coupling to interrogate the IC tag.

As mentioned above, the IC in the tracer particle may function as a tag giving the tracer particle its identity, enabling unique identification of each tracer particle. IC-tracer particles can optionally be linked to sensors. Information from the sensors may be conveyed to the outside of the tracer particle using the current or integrated state of the IC-tracer particles. A large number of unique IDs can be stored on an IC. This allows for large temporal and spatial resolution of a fluid provided with these tracer particles. This eliminates dispersion and selectivity problems associated with most ordinary tracers. The IC-tags may be selectively separated from the fluid and brought to a readout station for interrogation.

In a fluid system, readout using radio frequencies may not be practical. The present invention provides reader device for readout of information. The reader device is provided with a surface on which the IC-tracers assemble to enable readout of information. The surface area provides a number of readout locations. Each readout location is provided with either a contact device enabling electric connection to at least one terminal of a tracer particle or an electromagnetic coupling device enabling near field communication with an embedded electromagnetic coupling module of a tracer particle. The reader may readout the ID of the IC tracer particle. The reader may also write to the IC tracer particle to store information e.g. store a time or temperature from a sensor before the IC tracer particle is released from the reader. The reader device utilizes density and electrical or density and magnetic properties to bring the IC-tracers close to the surface of the reader device. The properties of the IC-tracers are tailored using properties of the shell, e.g. shell density, electrical properties or embedded magnetic subdomains in order to acquire such properties enabling assembly onto the reader surface. The reader periodically checks all read out locations in order to detect newly assembled tracer particles in order to start subsequent readout. The surface modification of the IC tracer particle may be a chemical surface modification. Furthermore, the outer surface of the shell may be shaped in a certain fashion and have imprinted surface modifications that will aid the IC particle in self-assembling onto the surface of the reader device. The reader device will typically be, but not limited to, e.g. a planar or cylindrical surface inserted into the flow. The local flow field may be manipulated such as to aid assembly on the surface of the device. Furthermore, the device may have the ability to set up local electric or magnetic fields to aid migration towards and assembly onto the surface of the readout device. The IC tracer ID is read through electrical sockets or using an electromagnetic coupling module. Periodically the readout device will purge its surface of the attached IC tracer particles in order to release these back to the flow and to free up readout locations on the surface. The readout locations have a surface modification that fits the surface shape and/or surface modification of the IC tracer particles so as to optimize self-assembly onto the surface. The readout locations may be provided with a chemical surface modification compatible to a chemical surface modification of the IC tracer particles.

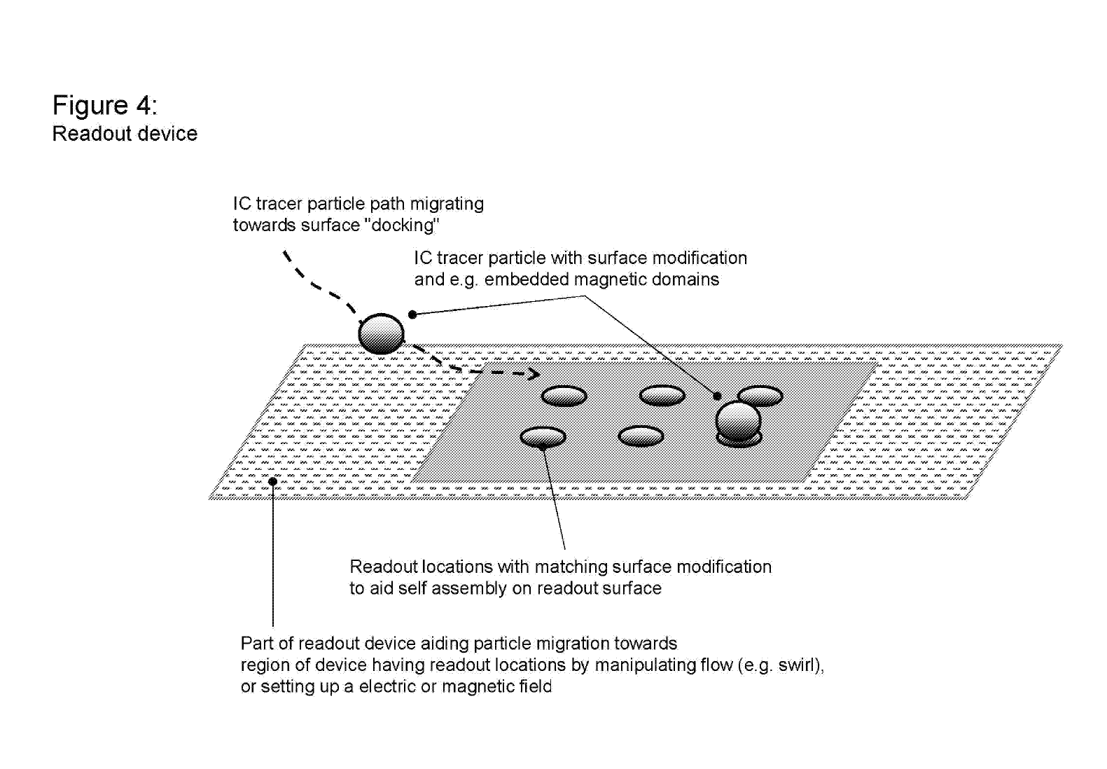

An embodiment of a part of the readout device is shown in FIG. 4. In FIG. 4 an IC tracer particle is migrating towards a surface docking area following the path indicated by the dotted line with arrow. The tracer particle is provided with a chemical surface modification and e.g. embedded magnetic domains. The readout locations are provided with matching/compatible surface modification for the tracer particle to aid self assembly of the tracer particle on the readout surface. The readout locations may also be provided with magnetic domains for attracting tracer particles with embedded magnetic domains. The tracer particle readout device is also provided with a guiding device aiding particle migration towards the region of the readout locations. The guiding device may be provided by a flow manipulating device (e.g. swirl element) or a device for setting up an electric or magnetic field. In FIG. 4 a part of the guiding device is illustrated. The docking surface for assembling and readout of a number of tracer particles is arranged on the guiding device.

The IC-tracer particle and optionally sensor and antenna may be incorporated into an IC-tracer particle by a shell/coating, where the shell/coating properties are tailored to the application. The shell/coating is substantially a material layer/coating encapsulating the IC-tag (and optionally sensor and antenna) with the intention to use it as a tracer in a fluid or solid system. The antenna should be configured in such a way, but not limited to, that the size, range and applicability to the process fluids at hand are optimal. In case the antenna is not incorporated into the particle, the particle needs to be designed such that it will dock selectively to a surface containing the antenna or reader hardware for readout as e.g. shown in the embodiment in FIG. 4.

The tracer particles are used in a method for monitoring processes in a system comprising a fluid with at least one fluid phase. At least one tracer particle is added at at least a first location in the system or the fluid. The at least one tracer particle is detected and identified at the at least one second location. Specific information may be derived from said detected and identified tracer particle. The tracer particles with integrated circuit providing unique identification of each tracer particle, are used in distinguishing said tracer particle from other tracer particles or groups of tracer particles. The tracer particles may be unambiguously distinguished from other tracer particles or groups of tracer particles.

Monitoring dispersion of more than one fluid phase may be performed by adding tracer particles with phase-specific miscibility to at least one of said system and fluid. The tracer particles are detected at the at least one second location. Dispersion of the tracer particles in at least one spatial direction in said system or fluid is accomplished by the unique identification of each tracer particle. Each tracer particle may thus be unambiguously distinguished from each other. Alternatively, groups of tracer particles may be unambiguously distinguished from other groups of tracer particles.

In the present invention a method is provided where the application of IC-technology is extended to tracing single- and multiphase fluids for characterization of process fluids and processing conditions. This enables, but is not limited to, detailed spatial and temporal information to be collected about the processing conditions and the process fluids. The tracers can be used both as passive tracers that convey information about position, velocity, density, and ID of tracers, information about spatial and or temporal release of tracers, and other state variables of the fluid or process.

A transition zone may be identified between at least two different fluid qualities or fluid origins passing consecutively through a part of the system by adding at least one detectable tracer particle into said transition zone between the at least two different fluids. At least one of said different fluid qualities may be passed to a selected part of the system. The selection may be performed on the basis of identifying the transition zone.

Tracers can be of single-type (all physical tracers share the same ID), group-type (a group of physical tracers share the same ID based on release conditions) or unique-type (all physical tracers have unique IDs). Using unique-type ICs storing a binary ID, short and long time autocorrelation functions or cross correlation functions can be obtained in single- or multiphase flows in pipes (not limited to but exemplified by oil/gas/condensate transport or water supply), reservoir monitoring (not limited to but exemplified by controlled release in oil and gas wells, aquifers, water wells, water pipelines and sewage networks), reactors (not limited to but exemplified by fluidized beds, bubble columns, slurry bubble columns, packed beds), processing equipment (not limited to but exemplified by cyclones, gravity separators, inline separators, scrubbers, flotation cells, screws, conveyors, silos, pumps, valves, coalescers, heat exchangers, absorbers, adsorbers, desorbers, injection moulding equipment, blow moulding equipment, hoppers and silos).

A few example applications are given below, but the invention is not limited to these examples.

### IC-Tracer Particle for Monitoring of Fluid Dispersion and Fluid Quality

An important task in characterization of process fluids and processing conditions is to quantify fluid dispersion in pipes or process vessels. By controlled release of one or several tracers at least at one location into the fluid and a number of detectors detecting these tracers downstream, both axial and radial dispersion can be characterized. The tracers may be detected at selected positions inside process vessels. Information concerning internal mixing and fluid circulation may also be sampled from the tracers.

In a single phase flow one can inject the IC-tracer particle at the transition (transition zone) between two product qualities or batches. This is the case when refinery products are piped between different locations in a pipe network. In this case the IC-tracer particle can be used as switch keys for directing the products to the correct location. Detectors are provided in the pipe wall. The detectors are either RF or electromagnet coupling units for readout. Readout can be improved by including magnetic embedment in the particle shell, facilitating movement of the tracer particles towards the wall in an applied external field.

Alternatively, a periodically timed injection into a production line can be used to characterize changes in processing conditions if key processing parameters are changed or the quality of the raw materials is changed. In this way parameters used in process simulation and control can be tuned using real data. The injection may be through injection nozzles or from a device that has a state dependent release (e.g. weathering of a seal restricting the particles).

In batch vessels tracers can be used to monitor processing conditions and fluid circulation continuously. A number of tracers are added at startup. The tracers are not replaced or pulsed in and thus remain in the fluid for a very long time.

Readout can occur whenever the particles are close to readout/interrogation stations located inside the vessel.

In multiphase systems of immiscible fluids surface treatment of the enclosure of the IC-tracer particle can be used to study phase separation and phase mixing. This adds a unique feature to the IC-tracer particles.

The IC-tracer particles can be selectively released into one of several immiscible fluid phases. In this case the presence of the IC-tracer particles will signal the presence of a particular phase.

IC tracer particles may be added into a fluid when said fluid changes at least one of its properties due to ambient changes. Such ambient changes may e.g. be a phase change from gas to liquid, or compositional change in either of the gas or liquid phase.

### Monitoring of Chemical or Physical Wear of Process Internals

In this application IC-tracer particles are embedded into lamella, where alternating layers of immobilized IC-tracer particles are separated by calibrated layers that have a well defined physical or chemical abrasive resistance. Thus one can continuously monitor the state of process equipment by detecting the presence of tracer particles in the flow. Examples include, but are not limited to, layered coating of pipe bends, T-junctions, valves and other critical pipe internals. Distributed location of layered coatings onto pipe or vessel walls can be used to monitor general wear in the process system based on the amount and type of tracer particles released into the flow. As the tracer particles are provided with their specific ID and may also include sensors, detailed monitoring of the state of specific parts and sections may be performed as a function of time.

### IC-Tracer Particle for Monitoring Flows in Hoppers, Feed Screws and Silos

In this application IC-tracer particles are added to the feed of for example a silo, and their passage through the system is monitored. The addition of temperature, stress or strain sensors (e.g. piezoelectric elements) into the particle could allow for local or integral measurements of the temperature, stress or strain inside the process conduits.

### Monitoring Flow in Molding Processes and Material Processing

In this application IC-tracer particles are added to the material to be used in a molding process (not limited to injection and blow molding) prior to molding and the evolution and final position of the tracers is monitored. This will give fundamental insight into the processing of molded parts.

In materials processing a plurality of tracer particles may be added to the production material at a first location. The production course and/or production quality of the material may be monitored at a second location both during and after production. The production process may be a storage process, and the production material then constitutes a material to be stored in a container.

### EXAMPLES

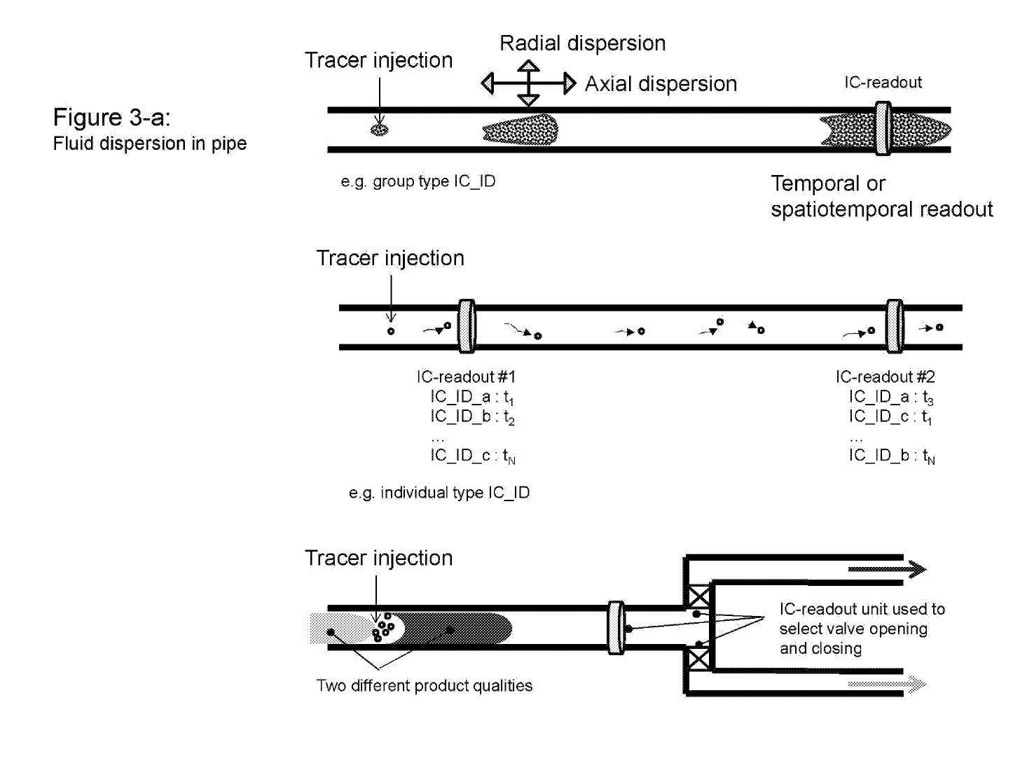

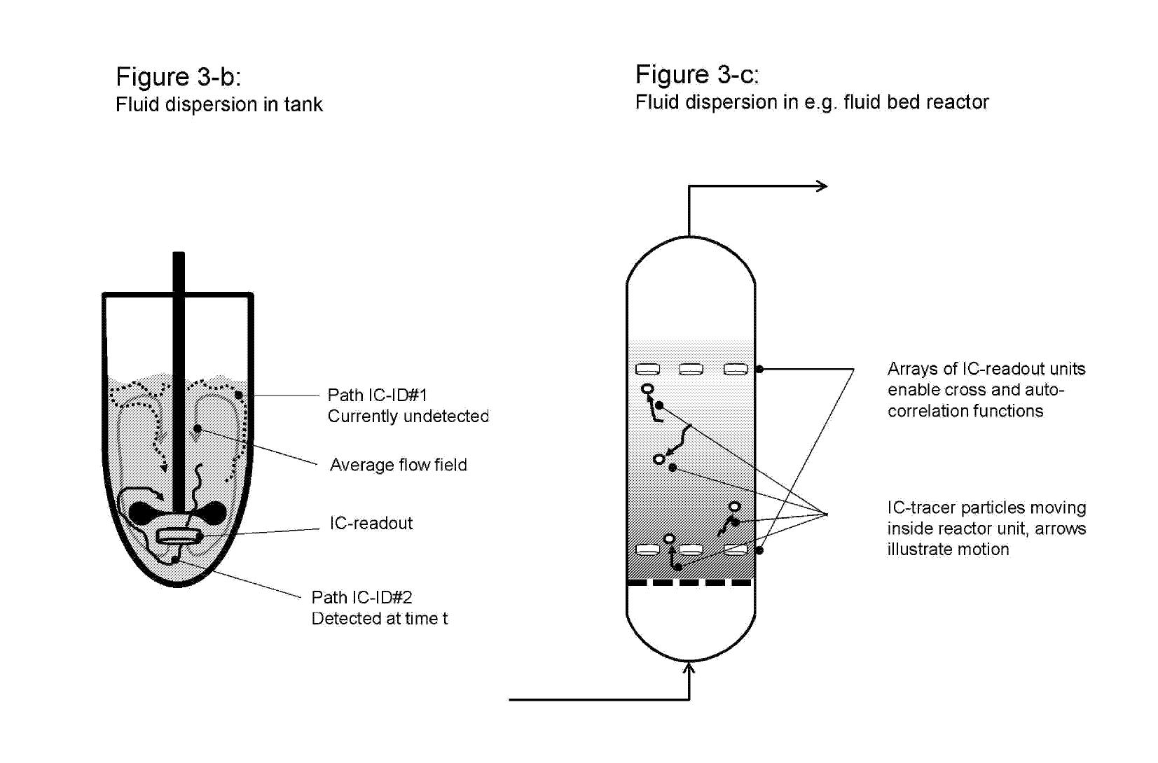

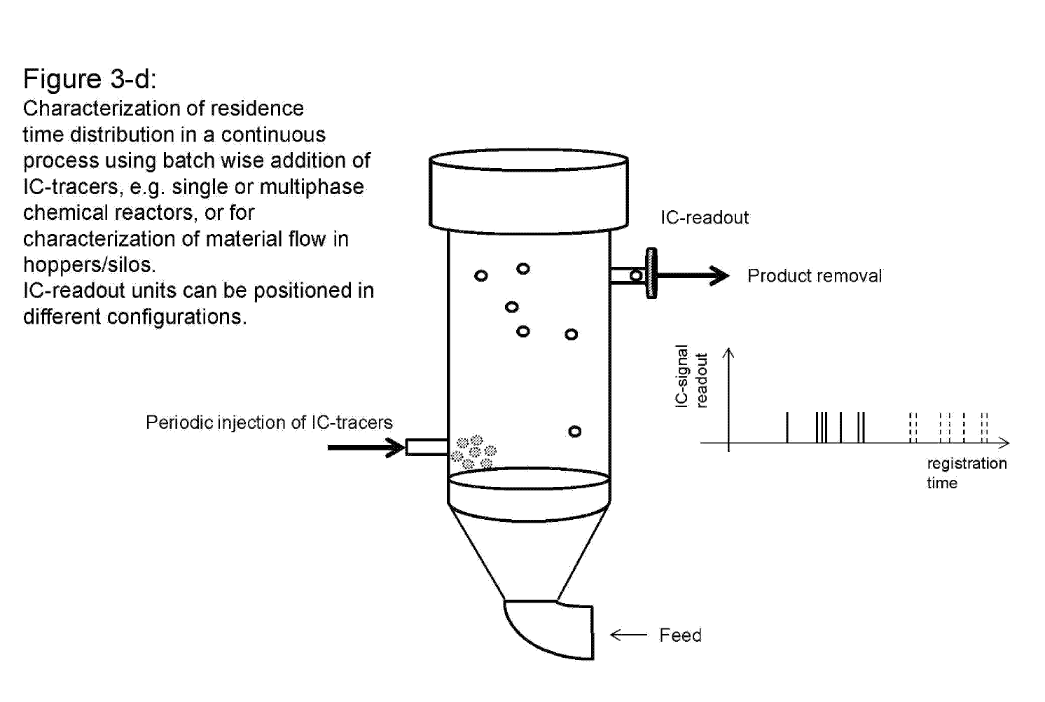

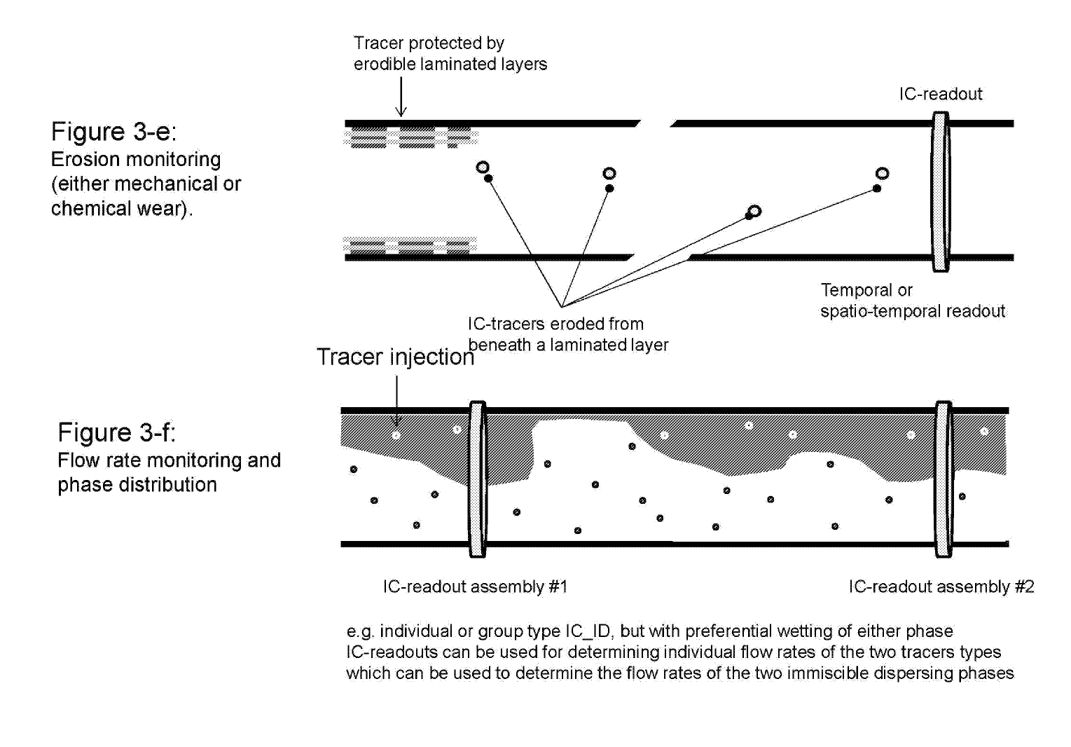

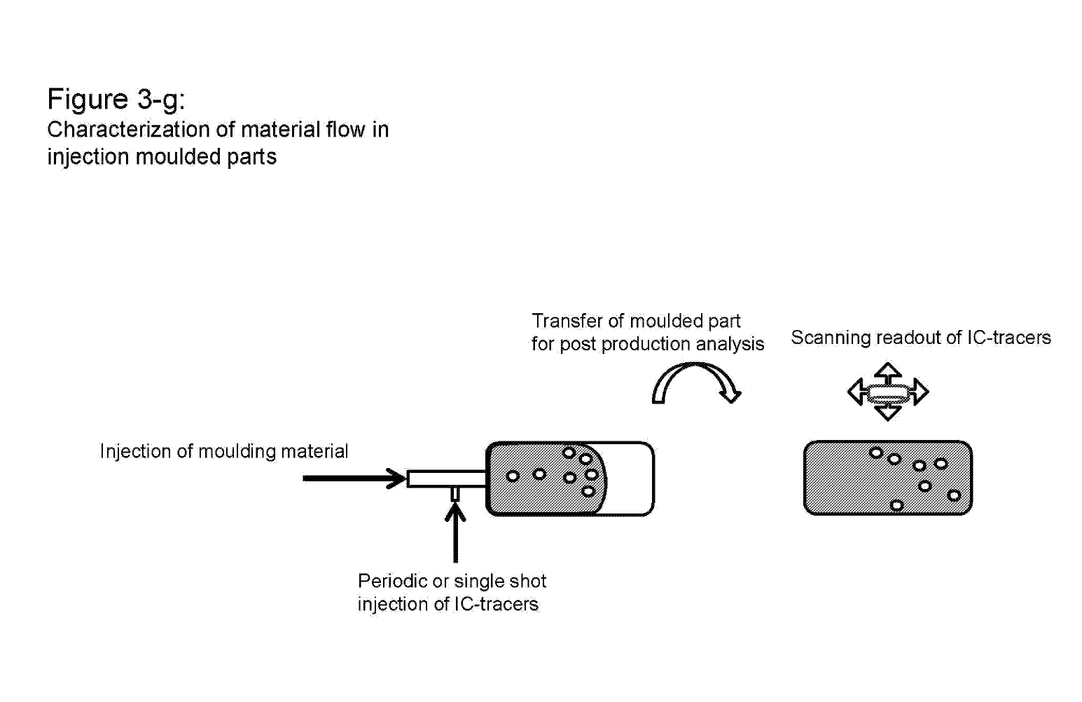

FIG. 3-a illustrates examples of monitoring of fluid dispersion in a pipe. In FIG. 3-a (top illustration) tracers (e.g group type IC_ID) are injected into the fluid at one location. The tracers undergo radial and axial dispersion in the fluid flow. The tracers are detected downstream at a detector (IC-readout). The detector provides temporal and spatiotemporal readout.

FIG. 3-a (illustration in the middle) illustrates tracer injection into the fluid in a pipe and tracer particle detection at two locations in the pipe; IC-readout # 1 and IC-readout # 2. Individual type IC_ID may be used. As an example the tracer IC_ID_a is detected at IC-readout # 1 at time t₁ and at time t₃ this tracer particle is detected at IC-readout # 2. Further, the tracer IC_ID_b is detected at IC-readout # 1 at time t₂ and at time t_{N} this tracer particle is detected at IC-readout # 2. The tracer particle IC_ID_c is detected at IC-readout # 1 at time t_{N} and at time t₁ this tracer particle is detected at IC-readout # 2.

FIG. 3-a (lower illustration) illustrates an example with tracer injection between two different product qualities of a fluid in a pipe. The tracers are detected in an IC-readout unit downstream. The IC-readout unit is used to select valve opening and closing for directing the two different product qualities into separate pipelines.

FIG. 3-b schematically illustrates an example of use of tracer particles for detection of fluid dispersion in a tank. The tank is in the illustration provided with a stirring means. A detector (IC readout) for detecting the tracer particles (IC_ID#1 . . . N) is provided in e.g. the lower part of the tank in the average flow field of the fluid in the tank. A path of a tracer particle ID_ID#2 detected by the detector at time t is shown by the bold black line. A path of a tracer particle IC_ID#1 which has not yet been detected is shown by the dotted line.

FIG. 3-c schematically illustrates an example of monitoring fluid dispersion in e.g. a fluid bed reactor. The tank in the example is provided with an inlet in the bottom of the tank and an outlet at the top of the tank. IC-tracer particles are moving inside the reactor unit as illustrated by the black arrows. Arrays of detectors (IC readout units) for the IC-tracer particles are provided in the lower part of the tank and in the upper part of the tank. These arrays of IC-readout units enable cross correlation functions and autocorrelation functions for the IC-tracer particles moving inside the reactor.

FIG. 3-d schematically illustrates an example of characterization of residence time distribution in a continuous process using batch wise addition of IC-tracer particles in e.g. a single or multiphase chemical reactor. The illustrated example may also apply for characterization of material flow in hoppers/silos. IC-readout units can be positioned in different configurations. The tank is provided with a feed from the underside of the tank and the product from the tank is taken out from the upper part of the tank through a product removal conduit. In the illustrated example in FIG. 3-d, the IC-tracer particles are injected periodically in the lower part of the tank. The IC-tracer particles move with the flow. A detector (IC-readout) for the IC-tracer particles is provided on the product removal conduit. The IC-tracer particles are detected by the detector as a function of time providing the residence time distribution.

FIG. 3-e schematically illustrates an example of erosion monitoring in a pipeline. The erosion monitoring may be due to either mechanical or chemical wear. Tracer particles are protected by erodible laminated layers arranged on the inside of the pipe wall. When a laminated layer is eroded, the tracer particles are exposed to the fluid flow in the pipe and eroded into the fluid flow. IC-tracers eroded from beneath a laminated layer is shown as dots in FIG. 3-e. A detector (IC-readout) is provided downstream enabling temporal and spatio-temporal readout. Monitoring of wear may be performed in a quantifying manner. Detection of the time between tracers of different detectable entity may provide an erosion rate. Instead of separate layers it is possible to have a continuous distribution of the tracer-IC particles in an erodible layer, providing a proportionability between the number of detected tracer-IC particles and the erosion depth.

FIG. 3-f schematically illustrates an example of flow rate monitoring and phase distribution of a multiphase fluid flow in a pipe. Tracer particles are injected into the fluid flow. Detectors (IC-readout assembly #1; IC-readout assembly #2) for detecting the injected tracer particles are provided at two downstream positions of the pipe. The tracer particles may be individual or group type tracer-IC particles (IC_ID), but with preferential wetting of either phase in the multiphase fluid flow. The IC-readouts can be used for determining individual flow rates of the two tracer-IC particle types. These individual flow rates can be used to determine the flow rates of the two immiscible dispersing phases in the fluid flow.

FIG. 3-g schematically illustrates an example of characterization of material flow in injection moulded parts. The moulding material is injected into the mould through a conduit. Tracer-IC particles are injected into the conduit for the moulding material before the mould. The injection of tracer-IC particles may be by periodic injection or single shot injection. The tracer-IC particles are seen as dots in the moulding material in the mould. After moulding the moulded part is transferred for post production analysis. The moulded part is scanned and the tracer-IC particles in the moulded part detected.

Having described preferred embodiments of the invention it will be apparent to those skilled in the art that other embodiments incorporating the concepts may be used. These and other examples of the invention illustrated above are intended by way of example only and the actual scope of the invention is to be determined from the following claims.

1-29. (canceled)

30. Tracer particle for monitoring processes in a system, said system comprising a fluid with at least one fluid phase, wherein the tracer particle comprises:
an integrated circuit providing a unique identification of the tracer particle, wherein the integrated circuit is enclosed/embedded in a coating/shell providing specific properties to said tracer particle in relation to at least one of
i said fluid;
ii ambient conditions in said system; and
iii detectability of the tracer particle; and
wherein the tracer particle further is provided with at least one terminal enabling electric connection of the tracer particle to a tracer particle reader device.

31. Tracer particle according to claim 30, wherein the integrated circuit is connected to the at least one terminal through wiring embedded in the coating/shell.

32. Tracer particle according to claim 30, wherein the coating/shell is provided with surface modifications or embedded modifications.

33. Tracer particle according to claim 30, comprising selecting said shell to provide the tracer particle with at least one specific property selected from a group comprising:
a protection against aggressive properties of said fluid,
b miscibility with at least one of said fluid phases,
c specific size,
d specific density,
e wear resistance,
f electrical properties,
g magnetic properties,
h optical properties, and
j ability to self-assemble on accommodated surfaces.

34. Tracer particle according to claim 31, wherein a sensor is connected to the embedded terminals.

35. Reader device for a tracer particle according to claim 30, the reader device comprising:
a surface area for assembling and readout of a number of tracer particles, the surface area comprising a number of readout locations,
wherein each readout location is provided with a contact device enabling electric connection to at least one terminal of a tracer particle.

36. Reader device according to claim 35, wherein the readout locations further are provided with a chemical surface modification compatible to a chemical surface modification of the tracer particles enabling an ability to self-assemble on accommodated surfaces.

37. Reader device according to claim 35, wherein the readout locations are provided with a surface modification corresponding to a shape of the tracer particles enabling an ability to self-assemble on accommodated surfaces.

38. Reader device according to claim 35, further comprising a guiding device aiding tracer particle migration towards the surface area.

39. Reader device according to claim 38, wherein the guiding device further comprises a manipulating device, e.g. in the form of a swirl element, operative for manipulating a local flow field.

40. Reader device according to claim 38, wherein the guiding device further comprises a device setting up local electric or magnetic fields aiding tracer particle migration towards and tracer particle assembly onto the surface of the readout device.

41. Use of tracer particles according to claim 30, and at least one reader device, for determining origins of the tracer particles in a system comprising a fluid with at least one fluid phase, the at least one reader device comprising:
a surface area for assembling and readout of a number of tracer particles, the surface area comprising a number of readout locations,
wherein each readout location is provided with a contact device enabling electric connection to at least one terminal of a tracer particle.

42. Method for monitoring processes in a system, said system comprising a fluid with at least one fluid phase, said method comprising:
adding at at least a first location at least one tracer particle as defined in claim 30 to at least one of said system and fluid,
separating the at least one tracer particle from the fluid, and
detecting and identifying said tracer particle at at least one second location.

43. Method according to claim 42, further comprising:
deriving specific information from said tracer particle at said second location; and
unambiguously distinguishing said tracer particle from other tracer particles or groups of tracer particles.

44. Method according to claim 42, further comprising monitoring dispersion of more than one fluid phase by adding tracer particles with phase-specific miscibility to at least one of said system and fluid and identifying the dispersion of the tracer particles in at least one spatial direction in said system or fluid.

45. Method according to claim 42, further comprising identifying a transition zone between at least two different fluid qualities or fluid origins passing consecutively through a part of said system by adding at least one detectable tracer particle into said boundary transition between the at least two different fluids.

46. Method according to claim 45, further comprising passing at least one of said different fluid qualities to a selected part of said system, said selection being performed on the basis of said transition zone identification.

47. Method according to claim 42, further comprising adding at least one tracer particle into said fluid when said fluid changes at least one of its properties due to ambient changes.

48. Method according to claim 42, further comprising monitoring wear of a surface of said system by arranging at least one tracer particle below said surface of the system and detecting said at least one tracer particle at a different location in said system indicating wear on said surface.

49. Method according to claim 48, further comprising arranging tracer particles with different detectable identity in layers on said surface enabling monitoring of said wear in a quantifying manner.

50. Use of a tracer particle according to claim 30 for tracing at least one of single- and multiphase fluids for characterization of process fluids and processing conditions.

51. Use according to claim 50 for obtaining at least one of short and long time autocorrelation or cross correlation functions in single- or multiphase flows in pipes.

52. Use according to claim 51, wherein the flow is an oil/gas/condensate transport or water supply.

53. Use of a tracer particle according to claim 30 for reservoir monitoring including controlled release in oil and gas reservoirs.

54. Use of a tracer particle according to claim 30 for monitoring at least one of aquifers, water wells, water pipelines and sewage networks.

55. Use according to claim 50 for obtaining at least one of short and long time autocorrelation or cross correlation functions in single- or multiphase flows in reactors including at least one of fluidized beds, bubble columns, slurry bubble columns and packed beds.

56. Use according to claim 50 for obtaining at least one of short and long time autocorrelation functions in single- or multiphase flow processing equipment, said processing equipment including at least one of cyclones, gravity separators, inline separators, scrubbers, flotation cells, screws, conveyors, silos, pumps, valves, coalescers, heat exchangers, absorbers, adsorbers, desorbers, injection moulding equipment, blow moulding equipment, hoppers and silos.
